(19) United States
(12) Patent Application Publication
(10) Pub. No.: US 2026/0017590 A1
(43) Pub. Date: Jan. 15, 2026

(54) Image to Structured Workflow Diagram Conversion

(71) Applicant: eBay Inc., San Jose, CA (US)

(72) Inventors: Yiming Huang, Shanghai (CN); Zhou Huang, Shanghai (CN); Ying Ma, Shanghai (CN); Chunjun Xiao, Shanghai (CN)

(73) Assignee: eBay Inc., San Jose, CA (US)

(21) Appl. No.: 18/771,568

(22) Filed: Jul. 12, 2024

(51) Int. Cl. G06Q 10/0633; G06T 7/13; G06T 7/50; G06T 11/20; G06V 10/48; G06V 20/70

(52) U.S. Cl. CPC G06Q 10/0633; G06T 7/13; G06T 7/50; G06T 11/206; G06V 10/48; G06V 20/70

(57) ABSTRACT

In accordance with techniques for image to structured workflow diagram conversion, an image of a human-drawn workflow diagram is received by a workflow platform. Using one or more image recognition algorithms, the workflow platform detects shapes and lines in the human-drawn workflow diagram, and in one or more implementations, the workflow platform extends the detected lines. Relationships between the shapes are determined based on relative positionings of the extended lines with respect to the shapes. The workflow platform is configured to generate a structured workflow diagram for display in a user interface, and the structured workflow diagram includes compute nodes representing the shapes that are connected by generated lines representing the relationships. In addition, a structured workflow file is generated representing the structured workflow diagram.

### BACKGROUND

Data workflow engineering is the practice of designing, building, and managing data workflows, which are sequences of processing tasks defining how data is ingested, processed, transformed, and/or stored. One specific example of a data workflow is an extract-transform-load (ETL) pipeline. An ETL pipeline defines how data is extracted from various data sources, how the extracted data is transformed (e.g., processed, manipulated, cleaned, restructured, aggregated, enriched, etc.) for analysis or consumption, and where the transformed data is loaded/stored. An important aspect of data workflow engineering is workflow orchestration which is the process of coordinating and scheduling the processing tasks of a data workflow, including defining dependencies between the processing tasks, defining an execution order of the processing tasks, and the like.

### SUMMARY

In accordance with the described techniques for image to structured workflow diagram conversion, a workflow platform receives an image of a human-drawn workflow diagram. Using one or more image recognition algorithms, the workflow platform detects shapes and lines in the human-drawn workflow diagram. In addition, the workflow platform refines the shapes and lines. To do so, the workflow platform identifies groups of shapes having centers that are within a threshold distance of one another, and generates merged shapes by merging the shapes in each group of shapes. In addition, the workflow platform identifies groups of lines having midpoints that are within a threshold distance of one another, and retains a single line from each group of lines. Furthermore, the workflow platform extends the retained lines.

In one or more implementations, the workflow platform determines relationships between the merged shapes based on relative positionings of the merged shapes with respect to the extended lines. The workflow platform further generates a structured workflow diagram for display in a user interface, and the structured workflow diagram includes compute nodes representing the shapes that are connected by generated lines representing the relationships. Further, a structured workflow file is generated in a configuration file format (e.g., XML, YAML, etc.) representing the structured workflow diagram.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques for image to structured workflow diagram conversion.

FIG. 2 depicts a system in an example implementation showing operation of a workflow conversion system to generate a structured workflow diagram and a corresponding structured workflow file.

FIG. 3 depicts an example in which a workflow conversion system converts a human-drawn workflow diagram to a structured workflow diagram.

FIG. 4 depicts an example in which a client device leverages a workflow platform of a service provider system to run a workflow embodied by a human-drawn workflow diagram.

FIG. 5 is a flow diagram depicting a procedure in an example implementation of image to structured workflow diagram conversion.

FIG. 6 illustrates an example system including various components of an example device that can be implemented as any type of computing device as described and/or utilized with reference to FIGS. 1-5 to implement embodiments of the techniques described herein.

### DETAILED DESCRIPTION

### Overview

Workflow orchestration is the process of coordinating and scheduling processing tasks of a data workflow, including defining dependencies between the processing tasks, defining an execution order of the processing tasks, and the like. As part of the workflow orchestration process, workflow diagrams are often generated. In general, a workflow diagram is representative of graphical programming logic including a plurality of nodes representing the processing tasks, and a plurality of connections (e.g., lines, directed edges, arrows) between the nodes representing relationships (e.g., dependencies) between the processing tasks. One example of a workflow diagram is a directed acyclic graph (DAG) in which nodes are connected by directed edges representing an ordering of the nodes that prevents loops or cycles.

As a preliminary step to workflow orchestration, data engineers often generate a crude human-made drawing of a workflow diagram (e.g., using a pen and paper) to map out and visualize how compute nodes interact, and the relationships/dependencies therebetween. Conventional workflow platforms enable data engineers to define data workflows diagrams via drag-and-drop user interfaces or domain-specific languages (DSLs). In a conventional drag-and-drop user interface, users drag and drop predefined process blocks into a canvas, and connect the predefined process blocks with directed links or edges. In a conventional DSL-based approach, a workflow platform defines its own DSL, and users leverage a text editor to define workflows using the DSL. These conventional methods, however, involve manually copying over the workflow embodied by the human-drawn workflow diagram into a medium that is understandable by the workflow platform. This can be a time consuming and tedious process.

Accordingly, techniques for image to structured workflow diagram conversion are described herein as implemented by a workflow platform. In accordance with the described techniques, a workflow platform receives an image of a human-drawn workflow diagram, and detects lines and shapes in the human-drawn workflow diagram. By way of example, the workflow platform employs Hough Lines Transforms and Hough Circles Transforms to detect lines and circles, respectively, in the human-drawn workflow diagram.

The workflow platform is configured to refine the shapes and the lines. As part of this, the workflow platform identifies at least one circle with an irregular radius and/or size. For example, the at least one circle has a radius that is at least a threshold amount larger or smaller than an average size of the detected circles in the human-drawn workflow diagram. Further, the workflow platform removes the at least one circle as an outlier, e.g., because the at least one circle was likely misrecognized and/or not intended by the user to represent a node of the workflow diagram.

Given the potential crudeness of the human-drawn workflow diagram, a single circle in the human-drawn workflow diagram is often identified as multiple circles, and a single line in the human-drawn workflow diagram is often detected as multiple lines. Thus, the workflow platform identifies groups of circles that are positionally proximate, e.g., the workflow platform identifies groups of circles having centers that are less than a threshold distance from one another. Further, the workflow platform merges the circles within a group of circles to form a merged circle, and this process is repeated on each group of circles. As a result, the workflow platform outputs refined shapes including the merged circles and excluding the at least one circle identified as an outlier.

Furthermore, the workflow platform identifies groups of lines that are positionally proximate, e.g., the workflow platform identifies groups of lines having midpoints that are less than a threshold distance from one another. Further, the workflow platform retains only one line from a group of lines, thereby deleting or removing the remaining lines in the group of lines. This process is repeated for each group of lines, resulting in a set of retained lines. In addition, the workflow platform extends the retained lines, e.g., to a border of the image of the human-drawn workflow diagram. As a result, the workflow platform outputs refined lines including the extended lines.

Next, the workflow platform establishes relationships between the refined shapes and the refined lines based on relative positionings of the refined shapes with respect to the refined lines. In this example, the relationships are dependency relationships. Given a refined line, for example, the workflow platform determines a distance between the refined line and each refined shape, as measured from a point on the refined line closest to the refined shape. Further, the workflow platform establishes a dependency relationship between the two refined shapes having the shortest determined distances. This process is repeated to determine a relationship between two refined shapes for each refined line.

In addition, the workflow platform identifies a directionality of the dependency relationship. For example, the workflow platform includes functionality for detecting arrows in the human-drawn workflow diagram, and directions in which the arrows are pointing. Given this, the workflow platform is configured to determine a directionality of the dependency relationship based on the direction of the arrow connecting the two refined shapes. Given a detected arrow pointing from a first refined shape to a second refined shape, for instance, the workflow platform determines that a node of the workflow diagram represented by the second refined shape is dependent on a node of the workflow diagram represented by the first refined shape.

The workflow platform is configured to generate a structured workflow diagram including compute nodes representing the refined shapes that are connected by generated lines/arrows connecting the refined shapes and representing the dependency relationships. Notably, the workflow platform is “structured” in the sense that the compute nodes and edges have a well-defined structure, organization, and/or formatting defined by the workflow platform. For example, the structured workflow diagram is representative of graphical programming logic in which the compute nodes correspond to particular operations, and the generated lines/arrows represent specific types of relationships, e.g., dependency relationships. In addition, the workflow platform generates a structured workflow file representing the structured workflow diagram. The structured workflow file is in a configuration file format, such as extensible markup language (XML) or YAML.

Thus, the described techniques automatically integrate a human-drawn workflow diagram into the workflow platform, a feature that was not previously made available via conventional workflow platforms. That is, other than user input to submit the human-drawn workflow diagram to the workflow platform, the conversion of the human-drawn workflow diagram to the structured workflow diagram and the structured workflow file occurs without human intervention. This contrasts with conventional workflow platforms that require a user to manually copy a human-drawn workflow diagram to the workflow platform, e.g., via many user inputs to drag-and-drop user interfaces and/or by manually coding workflow diagrams in a DSL.

Notably, manually copying a human-drawn workflow diagram to the workflow platform involves numerous computational processes. Such computational processes include exchanging data between remote servers of a workflow platform and local client devices (e.g., user inputs generating the workflow diagram and/or responses rendering the workflow diagram in accordance with the user input), and validating manually composed DSL code, e.g., often multiple times until valid DSL code is composed. Thus, by automatically integrating a human-drawn workflow diagram into the workflow platform, the described techniques conserve time and workflow platform resources (e.g., memory, processor bandwidth, network bandwidth) that may otherwise be used during the manual workflow integration process.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Workflow Conversion Environment

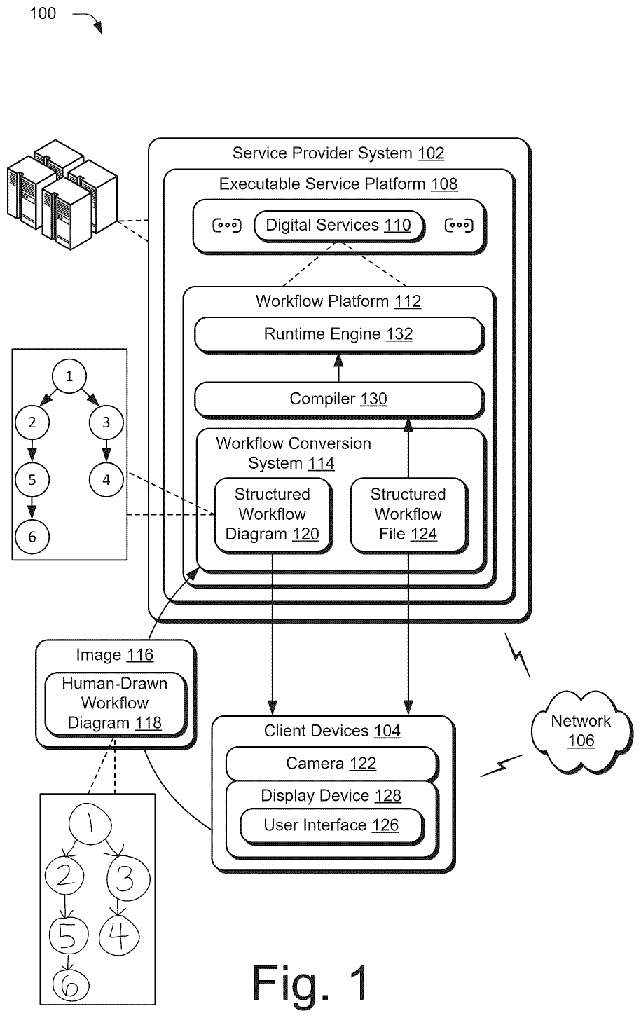

FIG. 1 is an illustration of a digital medium environment 100 in an example implementation that is operable to employ techniques for image to structured workflow diagram conversion. The illustrated environment 100 includes a service provider system 102, and a plurality of client devices 104 that are communicatively coupled, one to another, via a network 106. Computing devices that implement the service provider system 102 and the client devices 104 are configurable in a variety of ways.

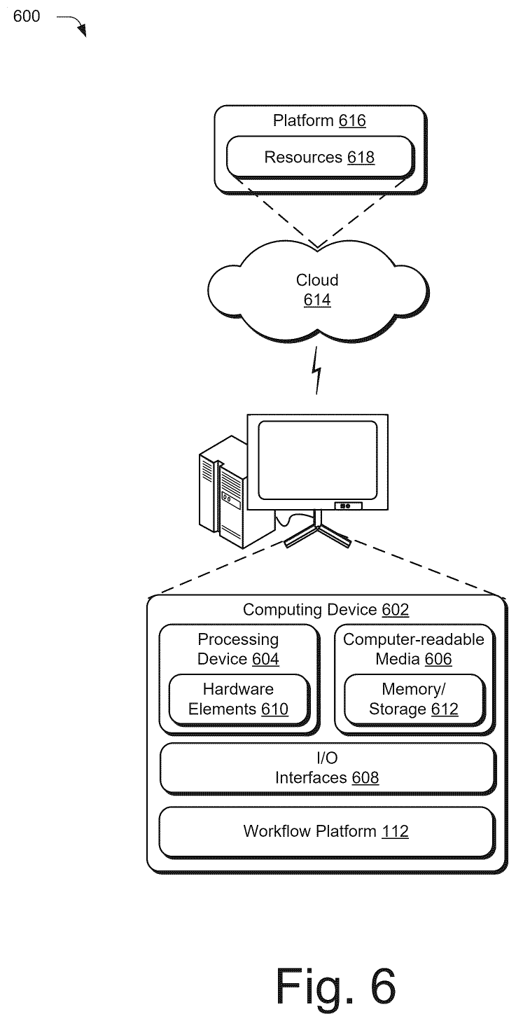

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, a computing device is also representative of a plurality of different devices, such as multiple servers utilized by a business to perform operations “over the cloud” as illustrated for the service provider system 102 and as described in FIG. 6.

The service provider system 102 includes an executable service platform 108. The executable service platform 108 is configured to implement and manage access to digital services 110 “in the cloud” that are accessible by the client devices 104 via the network 106. Thus, the executable service platform 108 provides an underlying infrastructure to manage execution of digital services 110, e.g., through control of underlying computational resources.

The executable service platform 108 supports numerous computational and technical advantages, including an ability of the service provider system 102 to readily scale resources to address wants of an entity associated with the client devices 104. Thus, instead of incurring an expense of purchasing and maintaining proprietary computer equipment for performing certain computational tasks, cloud computing provides the client devices 104 with access to a wide range of hardware and software resources so long as the client has access to the network 106.

Digital services 110 can take a variety of forms. Examples of digital services include social media services, document management services, storage services, media streaming services, content creation services, productivity services, digital marketplace services, auction services, and so forth. In some instances, the digital services 110 are implemented at least partially by a workflow platform 112 that supports functionality for designing, controlling, editing, executing, and monitoring data workflows.

Broadly, data workflows are sequences of processing tasks which define how data is ingested, processed, transformed, and/or stored. One specific example of a data workflow is an extract-transform-load (ETL) pipeline. An ETL pipeline defines how data is extracted from various data sources, how the extracted data is transformed (e.g., processed, manipulated, cleaned, restructured, aggregated, enriched, etc.) for analysis or consumption, and where the transformed data is loaded/stored.

In one or more implementations, the workflow platform 112 includes a workflow conversion system 114, which is representative of functionality for converting an image 116 of a human-drawn workflow diagram 118 to a structured workflow diagram 120. Generally, a workflow diagram is a topological graph including a plurality of compute nodes representing the processing tasks, and a plurality of lines (i.e., connections, edges) between the compute nodes representing relationships between the processing tasks. In various implementations, the relationships are dependency relationships. For example, a directed edge pointing from a first compute node to a second compute node in a workflow diagram indicates that the second compute node is executable only after the first compute node completes. In one or more examples, a workflow diagram (e.g., the human-drawn workflow diagram 118 and the structured workflow diagram 120) is a directed acyclic graph (DAG), in which the compute nodes are connected by directed edges representing an ordering of the compute nodes that prevents loops or cycles.

As shown, the workflow conversion system 114 is configured to receive the image 116 of the human-drawn workflow diagram 118 from a client device 104. In one or more examples, the human-drawn workflow diagram 118 is a workflow diagram drawn by a human user of the client device 104 using a physical drawing utensil (e.g., pen, pencil, etc.) on a physical drawing medium (e.g., paper, whiteboard, etc.), and the image 116 is captured using a camera 122 of the client device 104. In some examples, the human-drawn workflow diagram 118 is a workflow diagram drawn by a human user of the client device 104 using an electronic drawing medium (e.g., using a drawing application installed on the client device 104), and the image 116 is a screenshot depicting the human-drawn workflow diagram 118.

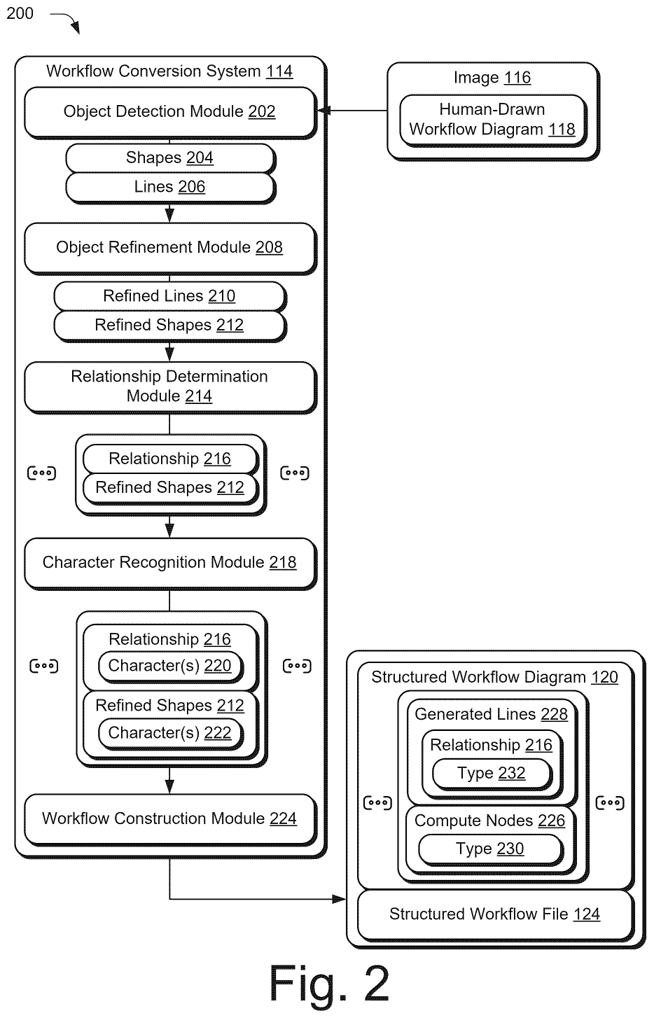

Broadly, the workflow conversion system 114 generates the structured workflow diagram 120 by detecting a plurality of shapes and lines in the image 116, recognizing the shapes as compute nodes of the structured workflow diagram 120, and recognizing the lines as relationships between the compute nodes, as further discussed below with reference to FIG. 2. Here, the structured workflow diagram 120 is “structured” in the sense that the compute nodes and connections/edges therebetween have a well-defined structure, organization, and/or formatting defined by the workflow platform 112. In other words, the structured workflow diagram 120 is representative of graphical programming logic in which the compute nodes of the structured workflow diagram 120 correspond to particular operations, and the lines connecting the compute nodes correspond to particular relationship types.

In addition to generating the structured workflow diagram 120, the workflow conversion system 114 generates a structured workflow file 124 representing the structured workflow diagram 120 in a configuration file format, e.g., Extensible Markup Language (XML), YAML, etc. Consider an example in which the structured workflow diagram includes a set of compute nodes representing a set of operations and a set of edges representing a set of relationships between the set of operations. In this example, the structured workflow file 124 represents the same set of operations and the same set of relationships in a configuration file format, rather than as graphical programming logic.

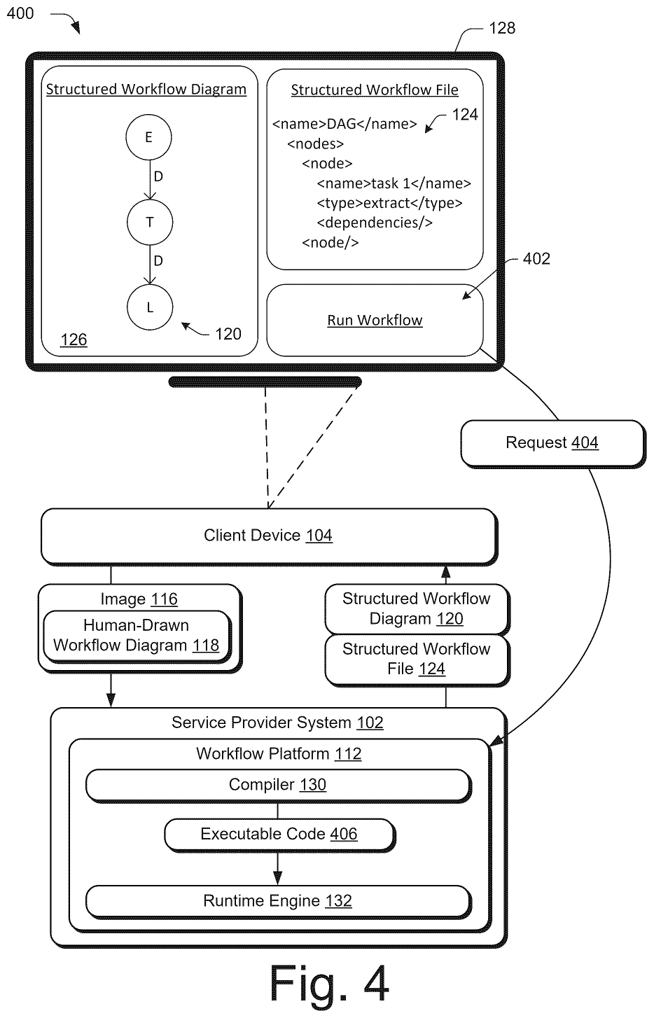

As shown, the workflow conversion system 114 returns the structured workflow diagram 120 and the structured workflow file 124 to the client device 104. In one or more implementations, the client device 104 displays the structured workflow diagram 120 and the structured workflow file 124, e.g., in a user interface 126 of a display device 128. As further discussed below with reference to FIG. 4, a user of the client device 104 optionally provides user input editing the structured workflow diagram 120 (e.g., adding compute nodes, adding edges/connections, changing relationship types, and changing operation types), and the user interface 126 displays a corresponding change in the structured workflow file 124. In addition, the user of the client device 104 is capable of providing user input requesting that the workflow platform run the workflow embodied by the structured workflow diagram 120 and the structured workflow file 124.

For instance, the workflow platform 112 includes a compiler 130, which is a software program that is configured to translate the structured workflow file 124 into executable code that is processable by a runtime engine 132 of the workflow platform 112. Broadly, the runtime engine 132 is a software program of the workflow platform 112 that interprets, schedules, executes, and manages data workflows, e.g., defined by users. As part of this, the runtime engine 132 allocates hardware resources (e.g., processing resources and memory) of the service provider system 102 to the processing tasks of the data workflow. Here, the workflow platform 112 receives a request from the client device 104 to run the data workflow of the structured workflow diagram 120, the compiler 130 translates the structured workflow file 124 to executable code, and the runtime engine 132 performs the workflow defined by the user (e.g., in the human-drawn workflow diagram 118) by running the executable code.

Conventional workflow platforms enable users to define workflows via drag-and-drop user interfaces or domain-specific languages (DSLs). Such drag-and-drop user interfaces allow users to drag and drop predefined process blocks into a canvas, and connect the predefined process blocks with directed links or edges. In a conventional DSL-based approach, a workflow platform defines its own DSL, enabling users to leverage a text editor to define workflows using the DSL. As a preliminary step to engineering a data workflow, developers and data engineers often generate a crude human-made drawing of the workflow diagram (e.g., using a pen and paper) to map out and visualize how compute nodes and relationships interact. Thus, users of these conventional workflow platforms undergo the tedious and time-consuming task of manually integrating the human-made drawing of the workflow diagram into the workflow platform.

In contrast, the described techniques automatically integrate the human-drawn workflow diagram 118 into the workflow platform 112. In other words, apart from user input to submit the human-drawn workflow diagram to the workflow platform 112 for conversion, the workflow platform 112 automatically generates the structured workflow diagram 120 and the structured workflow file 124 without human intervention. Therefore, the described techniques eliminate the time-consuming and tedious task of manually copying over the compute nodes and relationships embodied by the human-drawn workflow diagram 118 to a medium that is understandable by the workflow platform 112.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Workflow Conversion Features

FIG. 2 depicts a system 200 in an example implementation showing operation of a workflow conversion system to generate a structured workflow diagram and a corresponding structured workflow file. As shown, the workflow conversion system 114 receives the image 116 of the human-drawn workflow diagram 118. In particular, the image 116 of the human-drawn workflow diagram 118 is provided to an object detection module 202, which includes one or more image recognition algorithms for detecting shapes 204 and lines 206 in the human-drawn workflow diagram 118. In one or more examples, the object detection module 202 includes one or more image processing and computer vision algorithms, such as Hough Circles Transforms for detecting circles in images, and Hough Lines Transforms for detecting lines in images.

Additionally or alternatively, the object detection module 202 includes one or more machine learning models (e.g., convolutional neural networks (CNNs)) having been trained to detect shapes 204 and lines 206 within images, such as a HoughNet model. In one or more examples, the convolutional neural network is trained and/or refined using supervised learning. As part of this, training data is received including training images of human-drawn workflow diagrams, and labels identifying ground truth shapes and lines and ground truth coordinates of the underlying shapes and lines. Further, the convolutional neural network is employed to detect predicted shapes and predicted lines based on the training images, as well as predicted coordinates of the predicted shapes and predicted lines.

A loss is generated (e.g., using a loss function) based on differences between the ground truth shapes and the predicted shapes, differences between the ground truth lines and the predicted lines, and differences between the ground truth coordinates and the predicted coordinates. For example, the loss increases in correlation with a number of missed shapes and lines (e.g., ground truth shapes and ground truth lines that are not detected by the network), a number of wrongly classified shapes and lines (e.g., a square/box that is incorrectly detected as a set of lines), and an increased distance between the ground truth coordinates and the predicted coordinates. Moreover, parameters (e.g., internal weights) of the convolutional neural network are updated to reduce the loss. This process is repeated on different training samples of the training dataset until the loss converges to a minimum, a threshold number of iterations have completed, or a threshold number of epochs have been processed.

Regardless of the image recognition algorithm employed by the object detection module 202, the object detection module 202 is configured to extract coordinates of the shapes 204 and the lines 206 detected in the image 116 of the human-drawn workflow diagram 118. By way of example, the image 116 has a particular pixel by pixel resolution (e.g., 1024 pixels×1024 pixels), and the object detection module 202 identifies the pixelwise coordinates that make up the shapes 204, the lines 206. In addition, the object detection module 202 identifies pixelwise coordinates that correspond to endpoints and midpoints of the lines 206 and centers of the shapes 204.

In one or more implementations, the lines 206 are detected as arrows. In other words, the object detection module 202 includes functionality for detecting arrows in the image 116 of the human-drawn workflow diagram 118, and directions in which the arrows are pointing. In one or more examples, the object detection module 202 uses Hough Lines Transforms to detect one or more arrowhead lines located at or near an endpoint of one of the lines 206. Here, the object detection module 202 distinguishes arrowhead lines from arrow shaft lines (e.g., the lines 206) based on a size of the arrowhead lines relative to the arrow shaft lines, e.g., the arrowhead lines are at least a threshold amount smaller than the arrow shaft lines. In addition, the object detection module 202 determines a directionality of the line 206 (e.g., the arrow) based on one or more of: which endpoint of the line 206 the arrowhead lines are most proximally located and a direction in which a tip of the arrowhead lines is pointed. Additionally or alternatively, the convolutional neural network is specifically trained to detect arrows and the direction of arrows in images, e.g., using training data that includes ground truth arrows and ground truth directions in which the arrows are pointed.

As shown, the shapes 204 and lines 206 are provided as input to an object refinement module 208, which is representative of functionality for generating refined shapes 212 and refined lines 210 by refining the shapes 204 and the lines 206. Due to the roughness and/or crudeness of the human-drawn workflow diagram 118, it is possible that the object detection module 202 misrecognizes the shapes 204 and lines 206. In implementations in which the object detection module 202 employs Hough Lines Transforms, for instance, a singular line drawn with light pressure (and therefore having a relatively light shade) in the human-drawn workflow diagram 118 is often recognized as a plurality of lines by the object detection module 202. Similarly, when Hough Circles Transforms are implemented, a singular crudely drawn circle with an imperfectly round circumference is often recognized as a plurality of circles.

Given this, the object refinement module 208 is configured to identify a group of lines 206 having midpoints that are less than a threshold distance from one another, e.g., using the pixelwise coordinates of the midpoints of the lines 206 as extracted by the object detection module 202. Furthermore, the object refinement module 208 retains only one line from the group of lines 206, and as such, the object refinement module 208 removes or deletes the remaining lines in the group of lines 206. This process is repeated on different groups of lines 206 detected as having midpoints that are at least a threshold distance from one another.

As a result, the refined lines 210 exclude redundant and/or overlapping lines 206, and the refined lines 210 exhibit considerable separation distance therebetween. As further discussed below, the relationships between the refined shapes 212 are determined based on relative positionings of centers of the refined shapes 212 with respect to the refined lines 210. Thus, to better capture proximity of the refined lines 210 with respect to the refined shapes 212, the object refinement module 208 additionally extends the refined lines 210, e.g., to a border of the image 116.

Furthermore, the object refinement module 208 is configured to identify a group of circles (e.g., shapes 204) having centers that are less than a threshold distance from one another, e.g., based on the pixelwise coordinates of the centers of the circles as extracted by the object detection module 202. Furthermore, the object refinement module 208 merges the group of circles together to generate a single merged circle (e.g., a merged shape) from the group of circles. This process is repeated on different groups of circles detected as having centers that are less than a threshold distance from one another.

As a result, the object refinement module 208 replaces each group of proximate circles with a singular merged circle. In one or more implementations, the object refinement module 208 updates the sizes of the detected circles and/or the merged circles to have a uniform size. Therefore, the refined shapes 212 include a set of circles (e.g., including one or more merged circles, and the set of circles exhibit uniform roundness, a uniform size, and considerable separation distance therebetween. Although circles are discussed herein as an example, it is to be appreciated that similar operations are performable on different shapes 204 without departing from the spirit or scope of the described techniques.

In some implementations, the object refinement module 208 detects one or more shapes 204 having an irregular size with respect to the other detected shapes 204. Given this, the one or more shapes 204 are likely misrecognized by the object detection module 202 and/or are not intended by the user to correspond to compute nodes of the workflow diagram. Accordingly, the object refinement module 208 is configured to identify at least one shape 204 detected in the human-drawn workflow diagram 118 as an outlier shape based on a degree of difference between the at least one shape 204 and an average size of the shapes 204 in the human-drawn workflow diagram. For example, the at least one shape 204 is identified as an outlier shape based on the size of the at least one shape 204 being either a threshold amount larger or a threshold amount smaller than the average size of the shapes 204. The object refinement module 208 removes the at least one shape 204, resulting in a set of refined shapes 212 excluding the at least one shape 204.

As shown, the refined lines 210 and the refined shapes 212 are provided as input to the relationship determination module 214, which is representative of functionality for establishing relationships 216 between the refined shapes 212 based on relative positionings of the refined shapes 212 with respect to the refined lines 210. By way of example, the relationship determination module 214 identifies two refined shapes 212 that are positionally closest to a refined line 210. To do so, the relationship determination module 214 determines distances from the center of each respective refined shape 212 to a point on the refined line 210 that is positionally closest to the center of the respective refined shape 212. Further, the relationship determination module 214 establishes a relationship 216 between the two refined shapes 212 having the shortest determined distances to the refined line 210. This process is repeated for each refined line 210, thereby establishing a relationship 216 between two refined shapes 212 for each refined line 210.

As previously mentioned, the lines 206 are detected as arrows having an element of directionality in one or more implementations. Given this, the relationship determination module 214 establishes relationships between the refined shapes 212 based on directions in which the arrows point. For instance, a relationship 216 has an element of directionality corresponding to the directionality of the underlying arrow on the basis of which the relationship 216 is established. Consider an example in which the workflow platform 112 defines arrows as dependency relationships. In this example, a relationship 216 is established on the basis of an arrow pointing from a first shape 204 to a second shape 204. Given this, the relationship 216 indicates that a compute node to be generated from the second shape 204 is dependent on a compute node to be generated from the first shape 204.

In one or more implementations, a character recognition module 218 is employed to recognize characters (e.g., text, numbers, symbols) in the image 116 of the human-drawn workflow diagram 118, e.g., using an optical character recognition algorithm. In addition, the character recognition module 218 assigns the detected characters to the relationships 216 and refined shapes 212 based on proximity of the detected characters to the underlying refined lines 210 and the refined shapes 212, respectively. By way of example, the character recognition module 218 detects one or more characters 220 that are proximate to a refined line 210, and assigns the one or more characters to a relationship 216 established based on the refined line 210. Additionally or alternatively, the character recognition module 218 detects one or more characters 222 that are within (or proximate to) a refined shape 212, and assigns the one or more characters 222 to the refined shape 212.

In one or more examples, a character is determined to be proximate to and associated with a particular refined line 210 if the character is positionally closer to the midpoint of the particular refined line 210 than other refined shapes 212 and refined lines 210. Similarly, a character is determined to be proximate to and associated with a particular refined shape 212 if the character is positionally closer to the center of the particular refined shape 212 than other refined shapes 212 and refined lines 210.

As shown, the relationships 216 established between the refined shapes 212, as well as the characters 220, 222 assigned to the relationships 216 and the refined shapes 212 are provided as input to a workflow construction module 224. The workflow construction module 224 is configured to generate the structured workflow diagram 120 including compute nodes 226 representing the refined shapes 212 that are connected by generated lines 228 (or generated arrows) representing the relationships 216. In an example in which a relationship 216 is established between two refined shapes 212, for instance, the structured workflow diagram 120 includes two compute nodes 226 representing the two refined shapes 212. In addition, the structured workflow diagram 120 includes a generated line 228 (or a generated arrow) connecting the two compute nodes 226 and representing the relationship 216 therebetween.

In one or more implementations, the workflow construction module 224 is configured to assign operation types 230 to the compute nodes 226. In ETL pipelines, for example, operation types 230 assignable to the compute nodes 226 include extract operations which retrieve data from one or more data sources, transform operations which filter, aggregate, join, clean, enrich, and/or format the data, and load operations which store the transformed data to a target destination, e.g., a database. Extract, transform, and load operations are listed herein as example operation types 230, but it is to be appreciated that any of a variety of operation types 230 are assignable to the compute nodes 226.

In one example, an operation type 230 is assigned to a compute node 226 based on the character(s) 222 assigned to the underlying refined shape 212 represented by the compute node 226. For instance, the workflow platform 112 defines the letter ‘E’ as an extract operation, and as such, a refined shape 212 having an assigned character 222 of ‘E’ is converted to a compute node 226 having an extract operation type 230 in the structured workflow diagram 120.

In another example, the operation type 230 is assigned to a compute node based on a shape of the underlying refined shape 212 represented by the compute node 226. For instance, the workflow platform 112 defines a rectangle as an extract operation and a circle as a transform operation. Given this, the workflow construction module 224 converts a refined shape 212 detected as a rectangle to a compute node 226 having an extract operation type 230 in the structured workflow diagram 120. Further, the workflow construction module 224 converts a refined shape 212 detected as a circle to a compute node 226 having a transform operation type 230 in the structured workflow diagram 120.

In one or more implementations, the workflow construction module 224 assigns relationship types 232 to the generated lines 228. Example relationship types 232 include, but are not limited to, dependency relationships indicating that interconnected compute nodes 226 are dependent on one another, execution order relationships indicating that interconnected compute nodes 226 are to be executed in a particular order, and trigger relationships indicating that a compute node 226 is triggered or activated based on specific events or conditions.

In one example, the workflow construction module 224 assigns a default relationship type 232 to the generated lines 228 or generated arrows. For instance, the workflow platform 112 defines that arrows are indicative of dependency relationships. Consider an example in which a relationship 216 is established on the basis of an arrow pointing from a first refined shape 212 to a second refined shape 212. In this example, the workflow construction module 224 produces a generated arrow pointing from a first compute node 226 (representing the first refined shape 212) to a second compute node 226 (representing the second refined shape 212), and the generated arrow indicates that the second compute node 226 depends on the first compute node 226.

In another example, the workflow construction module 224 assigns relationship types 232 to the relationships 216 based on the character(s) 220 assigned to the relationship 216 by the character recognition module 218. For instance, the workflow platform 112 defines the letter ‘D’ as a dependency relationship. Consequently, a relationship 216 between two refined shapes 212 with an assigned character ‘D’ is converted to a generated line 228 indicating a dependency relationship between two corresponding compute nodes 226.

Additionally or alternatively, the workflow construction module 224 does not assign operation types 230 and relationship types 232 to one or more compute nodes 226 and/or one or more generated lines 228, respectively. As previously mentioned, for instance, the structured workflow diagram 120 is communicated to the client device 104, where the structured workflow diagram 120 is displayed in a user interface 126. Given this, the user is capable of providing user input via the user interface 126 updating and/or assigning operation types 230 and relationship types 232 to the compute nodes 226 and the generated lines 228, respectively, as further discussed below with reference to FIG. 4.

In one or more implementations, the workflow construction module 224 assigns labels or identifiers (IDs) to the relationships 216 and the compute nodes 226 based on the characters 220, 222. Consider an example in which a relationship 216 is assigned characters 220, and a refined shape 212 is assigned characters 222. In this example, the relationship 216 is given a label or identifier corresponding to the assigned characters 220, and a compute node 226 representing the refined shape 212 is given a label or identifier corresponding to the assigned characters 222. Here, a label or identifier in the structured workflow diagram 120 corresponds to characters positioned within, on, or proximate the compute nodes 226 and generated lines 228

In addition, the workflow construction module 224 generates the structured workflow file 124 representing the structured workflow diagram 120. By way of example, the workflow construction module 224 converts the structured workflow diagram 120 from graphical programming logic to a structured workflow file 124 in a configuration file format, e.g., XML, YAML. Here, the information that is present in the structured workflow diagram 120 (e.g., the compute nodes 226 defining processing tasks of certain operation types 230, the relationships 216 of certain relationship types 232 between the compute nodes 226, and/or labels assigned to the compute nodes 226 and generated lines/relationships 216) is also present in the structured workflow file 124.

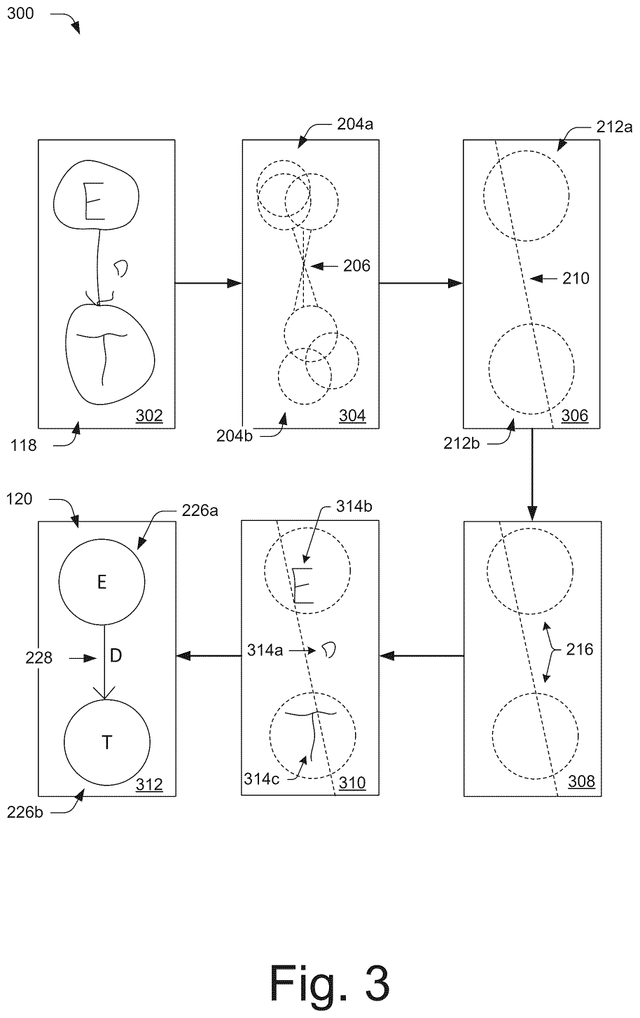

FIG. 3 depicts an example 300 in which a workflow conversion system converts a human-drawn workflow diagram to a structured workflow diagram. In particular, the example 300 depicts a plurality of stages 302, 304, 306, 308, 310, 312 of a workflow diagram as it is converted from the human-drawn workflow diagram 118 to the structured workflow diagram 120. For example, in a first stage 302, the human-drawn workflow diagram 118 is received from a client device 104. In a second stage 304, the object detection module 202 detects circles (e.g., shapes 204) and lines 206 in the human-drawn workflow diagram 118. Here, the crudely drawn circles in the human-drawn workflow diagram 118 are each detected as multiple circles, and the line in the human-drawn workflow diagram 118 is detected as multiple lines 206.

Thus, in the third stage 306, the object refinement module 208 merges a first group of circles 204a having centers within a threshold distance from one another to form a first merged circle, e.g., a first refined shape 212a. Moreover, the object refinement module 208 merges a second group of circles 204b having centers within a threshold distance from one another to form a second merged circle, e.g., a second refined shape 212b. In addition, the object refinement module 208 retains a single line from the group of lines 206 having midpoints within a threshold distance of one another, and extends the retained line, resulting in a refined line 210.

In the fourth stage 308, the relationship determination module 214 establishes a relationship 216 between the first refined shape 212a and the second refined shape 212b based on relative positionings of the refined shapes 212a, 212b with respect to the refined line 210. Moreover, the relationship determination module 214 determines a directionality of the relationship 216. For example, the object detection module 202 detects that one or more of the lines 206 are arrows, with a direction pointing from the first refined shape 212a to the second refined shape 212b. Given this, the relationship determination module 214 determines that the relationship 216 has a directionality from the first refined shape 212a to the second refined shape 212b. In the context of a directionality relationship, this means that a compute node 226 to be generated from the second refined shape 212b is dependent on a compute node 226 to be generated from the first refined shape 212a

In the fifth stage 310, the character recognition module 218 recognizes characters 314a, 314b, 314c in the human-drawn workflow diagram 118. The character recognition module 218 assigns a first character 314a (e.g., ‘D’) to the relationship 216, assigns a second character 314b (e.g., ‘E’) to the first refined shape 212a, and assigns a third character 314c (e.g., ‘T’) to the second refined shape 212b. This assignment of characters is based on relative positionings of the detected characters 314a, 314b, 314c with respect to the refined shapes 212a, 212b and the refined line 210.

In the sixth stage 312, the workflow construction module 224 generates the structured workflow diagram 120. Here, the structured workflow diagram 120 includes a first compute node 226a corresponding to the first refined shape 212a, a second compute node 226b corresponding to the second refined shape 212b, and a generated line 228 representing the relationship 216 between the compute nodes 226a, 226b.

In this example 300, the characters 314a, 314b, 314c are effective to assign operation types 230, relationship types 232, and labels. For instance, the workflow platform 112 defines the letter ‘E’ as corresponding to an extract operation, defines the letter ‘T’ as corresponding to a transform operation, and also defines the letter ‘D’ as corresponding to a dependency relationship. Since the character 314b (e.g., ‘E’) is assigned to the first refined shape 212a, the first compute node 226a representing the first refined shape 212a is associated with an extract operation type and a corresponding label, ‘E.’ Since the character 314c (e.g., ‘T’) is assigned to the second refined shape 212b, the compute node 226b representing the second refined shape 212b is associated with a transform operation type and a corresponding label, ‘T.’

Since the character 314a (e.g., ‘D’) is assigned to the relationship 216, the generated line 228 represents a dependency relationship, and the generated line 228 includes a corresponding label, ‘D.’ In addition, the generated line 228 is an arrow indicating the directionality of the dependency relationship, e.g., based on the directionality of the detected arrow. Here, the generated line 228 indicates that the second compute node 226b is dependent on the first compute node 226a, e.g., the processing task of the second compute node 226b is performable only after the processing task of the first compute node 226a completes.

FIG. 4 depicts an example 400 in which a client device leverages a workflow platform of a service provider system to run a workflow embodied by a human-drawn workflow diagram. In the example 400, the client device 104 includes a display device 128 displaying a user interface 126, e.g., of the workflow platform 112. Here, the client device 104 communicates the image 116 of the human-drawn workflow diagram 118 to the workflow platform 112 of the service provider system 102. The workflow platform 112 employs the workflow conversion system 114 to convert the image 116 of the human-drawn workflow diagram 118 to the structured workflow diagram 120 and the structured workflow file 124, in accordance with techniques discussed herein. Further, the workflow platform 112 communicates the structured workflow diagram 120 and the structured workflow file 124 back to the client device 104, and the client device 104 displays the structured workflow diagram 120 and the structured workflow file 124 in the user interface 126, as shown.

In one or more implementations, the user interface 126 supports functionality for editing and/or updating the structured workflow diagram 120 via user input. Examples of editing the structured workflow diagram 120 include adding or changing operation types 230 assigned to the compute nodes 226, adding or changing relationship types 232 assigned to the relationships 216 and/or generated lines 228, adding new compute nodes, and adding new directed edges representing new relationships 216. In one or more examples, the updated structured workflow diagram 120 is communicated back to the workflow platform 112, which employs the workflow construction module 224 to generate an updated structured workflow file 124 representing the updated structured workflow diagram 120, e.g., reflecting the updates to the structured workflow diagram 120. In various implementations, the updated structured workflow file 124 is communicated to the client device 104, which displays the updated structured workflow file 124. In other words, changes made to the structured workflow diagram 120 via user input produce corresponding changes to the structured workflow file 124 in the user interface 126.

As shown, the user interface 126 includes a user interface element 402 that is selectable to run the workflow embodied by the structured workflow diagram 120 and the structured workflow file 124. In response to a user selection of the user interface element 402, for example, the client device 104 communicates a request 404 to the workflow platform 112, requesting that the workflow platform 112 run, process, and/or execute the workflow. To do so, the compiler 130 translates the structured workflow file 124 to executable code 406 interpretable by the runtime engine 132, and the runtime engine 132 runs the executable code 406.

### Example Procedure

The following discussion describes techniques that are configured to be implemented utilizing the previously described systems and devices. Aspects of each of the procedures are configured for implementation in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-4.

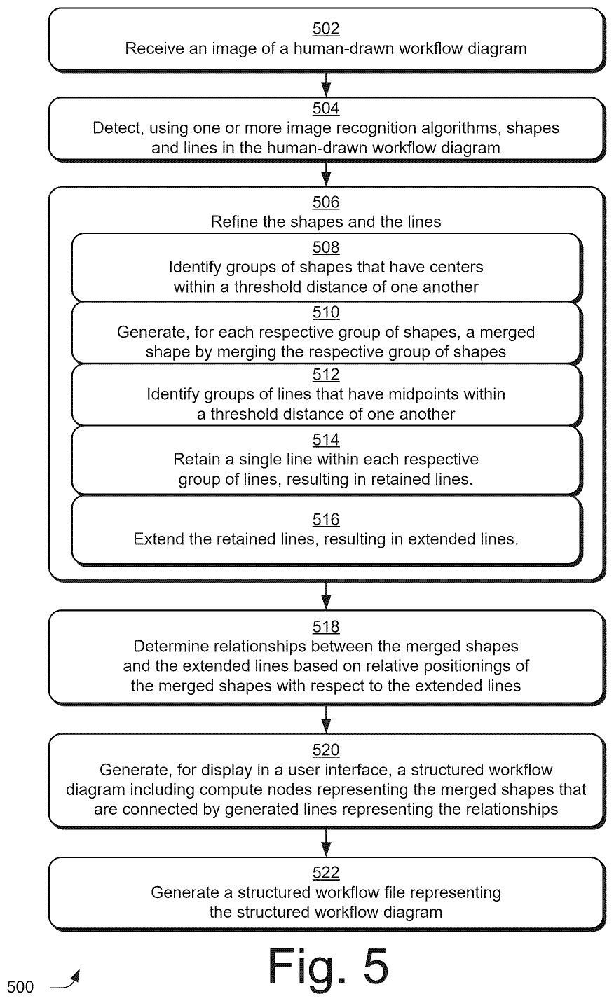

FIG. 5 is a flow diagram depicting a procedure 500 in an example implementation of image to structured workflow diagram conversion. In the procedure 500, an image of a human-drawn workflow diagram is received (block 502). By way of example, the workflow platform 112 receives the image 116 of the human-drawn workflow diagram 118.

Shapes and lines are detected in the human-drawn workflow diagram using one or more image recognition algorithms (block 504). By way of example, the object detection module 202 detects shapes 204 and lines 206 in the human-drawn workflow diagram 118. In variations, the shapes 204 and lines 206 are detected using Hough Lines Transforms, Hough Circles Transforms, and/or a convolutional neural network having been trained to detect shapes and lines in human-drawn images.

The shapes and the lines are refined (block 506), and as part of this, groups of shapes are identified that have centers within a threshold distance of one another (block 508). For example, the object refinement module 208 identifies groups of circles having centers that are within a threshold distance of one another.

For each respective group of shapes, a merged shape is generated by merging the respective group of shapes (block 510). By way of example, the object refinement module 208 merges a group of circles having centers that are within a threshold percentage of one another to form a singular merged circle from the group of circles. This process is repeated for each group of circles having proximate centers. As a result, the object refinement module 208 outputs refined shapes 212, and the refined shapes 212 include the merged circles.

Groups of lines are identified that have midpoints within a threshold distance of one another (block 512). For example, the object refinement module 208 identifies groups of lines 206 having midpoints that are within a threshold distance of one another.

A single line within each respective group of lines is retained, resulting in retained lines (block 514). By way of example, the object refinement module 208 retains a single line from a group of lines 206 having midpoints within a threshold distance of one another, thereby removing and/or deleting the remaining lines 206 of the group of lines 206. This process is repeated for each group of lines 206 having proximate midpoints.

The retained lines are extended, resulting in extended lines (block 516). For example, the object refinement module 208 extends the retained lines, resulting in extended lines e.g., so that both endpoints of an extended line reach a border of the image 116.

Relationships are determined between the merged shapes and the extended lines based on relative positionings of the merged shapes with respect to the extended lines (block 518). As part of this, the relationship determination module 214 determines relationships 216 between the merged circles (i.e., merged shapes) based on relative positionings of the extended lines with respect to the merged circles. For example, a relationship 216 is established between two merged circles on the basis of an extended line because the two merged circles are the two refined shapes 212 that are closest to the extended line.

A structured workflow diagram is generated for display in a user interface, and the structured workflow diagram includes compute nodes representing the merged shapes that are connected by generated lines representing the relationships (block 520). By way of example, the workflow construction module 224 generates the structured workflow diagram 120 and communicates the structured workflow diagram 120 for display in the user interface 126 of the client device 104. In particular, the structured workflow diagram 120 includes compute nodes 226 corresponding to the merged circles (i.e., merged shapes), and generated lines 228 or generated arrows connecting the compute nodes 226 and representing the relationships 216 between the compute nodes 226. In one or more implementations, the compute nodes 226 are associated with operation types (e.g., extract, transform, or load operation types), and the generated lines 228 represent relationships 216 of certain relationship types, e.g., dependency relationships, execution order relationships, or trigger relationships.

A structured workflow file is generated representing the structured workflow diagram (block 522). For example, the workflow construction module 224 additionally generates a structured workflow file 124 representing the structured workflow diagram 120 in a configuration file format, e.g., XML, YAML, etc.

### Example System and Device

FIG. 6 illustrates an example system 600 that includes an example computing device 602 that is representative of one or more computing systems and/or devices that implement the various techniques described herein. This is illustrated through inclusion of the workflow platform 112. The computing device 602 is configurable, for example, as a server of a service provider, a device associated with a client (e.g., a client device 104), an on-chip system, and/or any other suitable computing device or computing system.

The example computing device 602 as illustrated includes a processing device 604, one or more computer-readable media 606, and one or more input/output (I/O) interfaces 608 that are communicatively coupled, one to another. Although not shown, the computing device 602 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 604 is representative of functionality to perform one or more operations using hardware. Accordingly, the processing device 604 is illustrated as including hardware element 610 that is configurable as processors, functional blocks, and so forth. This includes implementation in hardware as an application specific integrated circuit or other logic device formed using one or more semiconductors. The hardware elements 610 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 606 is illustrated as including memory/storage 612 that stores instructions that are executable to cause the processing device 604 to perform operations. The memory/storage 612 represents memory/storage capacity associated with one or more computer-readable media. The memory/storage 612 includes volatile media (such as random access memory (RAM)) and/or nonvolatile media (such as read only memory (ROM), Flash memory, optical disks, magnetic disks, and so forth). The memory/storage 612 includes fixed media (e.g., RAM, ROM, a fixed hard drive, and so on) as well as removable media (e.g., Flash memory, a removable hard drive, an optical disc, and so forth). The computer-readable media 606 is configurable in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” “component,” “system,” and “platform” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 602. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 602, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 610. The computing device 602 is configured to implement particular instructions and/or functions corresponding to the software and/or hardware modules. Accordingly, implementation of a module that is executable by the computing device 602 as software is achieved at least partially in hardware, e.g., through use of computer-readable storage media and/or hardware elements 610 of the processing device 604. The instructions and/or functions are executable/operable by one or more articles of manufacture (for example, one or more computing devices 602 and/or processing devices 604) to implement techniques, modules, and examples described herein.

The techniques described herein are supported by various configurations of the computing device 602 and are not limited to the specific examples of the techniques described herein. This functionality is also implementable all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 include applications and/or data that can be utilized while computer processing is executed on servers that are remote from the computing device 602. Resources 618 can also include services provided over the Internet and/or through a subscriber network, such as a cellular or Wi-Fi network.

The platform 616 abstracts resources and functions to connect the computing device 602 with other computing devices. The platform 616 also serves to abstract scaling of resources to provide a corresponding level of scale to encountered demand for the resources 618 that are implemented via the platform 616. Accordingly, in an interconnected device embodiment, implementation of functionality described herein is distributable throughout the system 600. For example, the functionality is implementable in part on the computing device 602 as well as via the platform 616 that abstracts the functionality of the cloud 614.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by at least one computing device, the method comprising:
receiving an image of a human-drawn workflow diagram;
detecting, using one or more image recognition algorithms, shapes and lines in the human-drawn workflow diagram;
extending the lines detected in the human-drawn workflow diagram;
determining relationships between the shapes based on relative positionings of the extended lines with respect to the shapes;
generating, for display in a user interface, a structured workflow diagram including compute nodes representing the shapes that are connected by generated lines representing the relationships; and
generating a structured workflow file representing the structured workflow diagram.

2. The method of claim 1, wherein detecting the shapes and the lines includes extracting coordinates of the shapes and the lines within the image, and determining the relationships is based on the coordinates.

3. The method of claim 1, wherein detecting the shapes and the lines includes detecting the shapes and the lines using a convolutional neural network having been trained to detect the shapes and the lines within images of human-drawn objects.

4. The method of claim 1, wherein detecting the shapes and the lines includes detecting the shapes and the lines in the human-drawn workflow diagram using Hough Circles Transforms and Hough Lines Transforms.

5. The method of claim 1, wherein detecting the lines includes detecting multiple lines having midpoints that are less than a threshold distance from one another and retaining a single line of the multiple lines, wherein determining the relationships includes determining a relationship between two shapes based on the single line.

6. The method of claim 1, further comprising removing at least one shape detected in the human-drawn workflow diagram based on a degree of difference between a size of the at least one shape relative to an average size of the shapes in the human-drawn workflow diagram, wherein determining the relationships is based on the relative positionings of the lines with respect to the shapes excluding the at least one shape.

7. The method of claim 1, wherein detecting the shapes includes detecting multiple shapes having centers that are within a threshold distance from one another and generating a merged shape by merging the multiple shapes, wherein determining the relationships includes determining a relationship between the merged shape and an additional shape.

8. The method of claim 1, wherein detecting the lines includes detecting arrows and directions in which the arrows are pointed, wherein determining the relationships is further based on the directions.

9. The method of claim 1, further comprising:
detecting, using an optical character recognition algorithm, characters in the human-drawn workflow diagram;
assigning the characters to the shapes and the lines based on relative positionings of the characters with respect to the shapes and the lines, respectively;
associating the compute nodes with operation types corresponding to the characters assigned to the shapes; and
associating the relationships with relationship types corresponding to the characters assigned to the lines.

10. The method of claim 1, further comprising:
detecting, using an optical character recognition algorithm, characters in the human-drawn workflow diagram;
assigning the characters to the shapes and the lines based on relative positionings of the characters with respect to the shapes and the lines, respectively; and
labeling the compute nodes and the generated lines with identifiers in the structured workflow diagram based on the characters assigned to the shapes and the lines, respectively.

11. The method of claim 1, wherein detecting the shapes includes detecting different shape types in the human-drawn workflow diagram, wherein generating the structured workflow file includes associating the compute nodes in the structured workflow file with different operation types corresponding to the different shape types.

12. The method of claim 1, further comprising compiling the structured workflow file into executable code, and running the executable code.

13. A system, comprising:
at least one processor; and
a memory storing instructions, which when executed by the at least one processor, cause the at least one processor to perform operations including:
receiving an image of a human-drawn workflow diagram;
detecting, using one or more image recognition algorithms, multiple shapes and multiple lines having midpoints that are less than a threshold distance from one another in the human-drawn workflow diagram;
retaining a single line of the multiple lines by removing one or more lines of the multiple lines;
determining a relationship between the multiple shapes based on a relative positioning of the single line with respect to the multiple shapes;
generating, for display in a user interface, a structured workflow diagram including compute nodes representing the multiple shapes that are connected by a generated line representing the relationship; and
generating a structured workflow file representing the structured workflow diagram.

14. The system of claim 13, the operations further including removing at least one shape detected in the human-drawn workflow diagram based on a degree of difference between a size of the at least one shape relative to an average size of the multiple shapes in the human-drawn workflow diagram, wherein determining the relationship is based on the relative positioning of the single line with respect to the multiple shapes excluding the at least one shape.

15. The system of claim 13, wherein detecting the multiple shapes includes detecting two or more shapes having centers that are within a threshold distance from one another and generating a merged shape by merging the two or more shapes, wherein determining the relationship includes determining the relationship between the merged shape and an additional shape of the multiple shapes.

16. The system of claim 13, the operations further comprising extending the single line, resulting in an extended line, wherein determining the relationship is based on the relative positioning of the extended line with respect to the multiple shapes.

17. One or more non-transitory computer-readable storage media storing instructions that, responsive to execution by at least one processing device, cause the at least one processing device to perform operations including:
receiving an image of a human-drawn workflow diagram;
detecting, using one or more image recognition algorithms, multiple shapes and a line in the human-drawn workflow diagram, the multiple shapes including two or more shapes having centers that are less than a threshold distance from one another;
generating a merged shape by merging the two or more shapes;
determining a relationship between the merged shape and an additional shape of the multiple shapes based on a relative positioning of the line with respect to the merged shape and the additional shape;
generating, for display in a user interface, a structured workflow diagram including compute nodes representing the merged shape and the additional shape that are connected by a generated line representing the relationship; and
generating a structured workflow file representing the structured workflow diagram.

18. The one or more non-transitory computer-readable storage media of claim 17, wherein detecting the line includes detecting multiple lines having midpoints that are less than a threshold distance from one another and retaining, as the line, a single line of the multiple lines.

19. The one or more non-transitory computer-readable storage media of claim 17, the operations further comprising extending the line, resulting in an extended line, wherein determining the relationship is based on the relative positioning of the extended line with respect to the multiple shapes.

20. The one or more non-transitory computer-readable storage media of claim 17, further comprising compiling the structured workflow file into executable code, and running the executable code.
